(19) United States
(12) Patent Application Publication
(10) Pub. No.: US 2016/0371389 A1
(43) Pub. Date: Dec. 22, 2016

(54) METHOD OF PRESENTING INFORMATION ON A SEARCH RESULT PAGE

(71) Applicant: YANDEX EUROPE AG, Luzern (CH)

(72) Inventors: Ilya Valentinovich SEGALOVICH, Moscow (RU); Aleh Viktorovich LIAUCHUK, Minsk (BY); Denis Olegovich IVANOV, Saint Petersburg (RU); Anton Aleksandrovich IVANOV, Saint-Petersburg (RU); Vladimir Andreevich GOROVOY, Saint-Petersburg (RU); Dmitrii Anatolievich SHCHITININ, Saint-Petersburg (RU); Ivan Andreevich KOZHEVNIKOV, Syktyvkar, Republic of Komi (RU)

(21) Appl. No.: 15/035,850

(22) PCT Filed: Nov. 15, 2013
(86) PCT No.: PCT/RU2013/001027

§ 371 Date: Sep. 6, 2016

(51) Int. Cl. G06F 17/30

(52) U.S. Cl. CPC G06F 17/30882; G06F 17/30873; G06F 17/30864

(57) ABSTRACT

A method of presenting a search result page (SERP) to a user in response lo a search query. The method can be executable at a server. The method comprises generating an interactive snippet field on the SHRP in association with a resource, the resource being responsive to the search query; allowing for a two-way communication between the interactive snippet field and the resource such that at least a portion of the interactive snippet field can be updated based on (i) a First data component received from the user via the interactive snippet field and (ii) a second data component received from the resource.

### CROSS-REFERENCE

None.

### FIELD

The present technology relates to search engines in general and specifically to a system and method for presenting information on a search result page.

### BACKGROUND

Various global or local communications networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

Generally speaking, a given user can access a resource on the communications network by two principle means. The given user can access a particular resource directly, either by typing an address of the resource (typically an URL or Universal Resource Locator, such as www.webpage.com) or by clicking a link in an e-mail or in another web resource. Alternatively, the given user may conduct a search using a search engine to locate a resource of interest. The latter is particularly suitable in those circumstances, where the given user knows a topic of interest, but does not know the exact address of the resource she is interested in.

There are numerous search engines available to the user. Some of them are considered to be general purpose search engines (such as Yandex™, Google™, Yahoo™ and the like).

Others are considered to be vertical search engines i.e. search engines dedicated to a particular topic of search—such as Momondo™ search engine dedicated to searching flights.

Irrespective of which search engine is used, the search engine is generally configured to receive a search query from a user, to perform a search and to return a ranked search result page (SERP) to the user. Several attempts have been made to improve the design of the SERP in the strive to enable the user to more easily and faster appreciate search results.

For example, where a user uses the Google™ search engine to search for exchange rates. For example, the user may have entered a search query “Exchange rate 1 Canadian Dollar to US Dollar”. The user is presented with a SERP a screenshot of which is depicted in FIG. 1 as a screenshot 100. Within the screen shot 100, the user is presented with several conventionally-known fields. Amongst these fields are: a query interface 102 and a search results interface 104. The general purpose of the query interface 102 is to enable the user (not depicted) to enter her query or a “search string” (which in this case is “Exchange rate 1 Canadian Dollar to US Dollar”). The general purpose of the search results interface 104 is to provide search results that are responsive to the user query entered into the query interface 102.

Within the search results interface 104 there is shown a SERP 106, the SERP 106 having several components. Within the SERP 106, there is provided an advertising portion 108 containing, one or more sponsored or paid-for messages, a general search result portion 110 (containing general search results) and a widget portion 112. Within the widget portion 112, the user is able to undertake several interactive actions. For example, the user is able to change the amount and/or the currencies involved in the exchange rate calculations. Responsive to the user changes, the widget potion 112 provides the appropriate answer. Now, it should be noted that the widget portion 112 is associated with a vertical service of Google—in other words, it was specifically built for the Google currency exchange vertical service.

In another example, let it be assumed that the user has typed in a query (using the query interface 102), the query containing: “Cheap flights Toronto to Moscow”. The user is presented with a SERP a screenshot of which is represented in FIG. 2 as a screenshot 200. Within the screen shot 200, the user is presented with several conventionally-known fields. Amongst these fields are: a query interface 102 and a search results interface 104. Within the search results interface 104 there is shown a SERP 206, the SERP 206 having several components. Within the SERP 206, there is provided an advertising portion 208 containing one or more sponsored or paid-for messages, a general search result portion 210 (containing general search results) and a widget portion 212. Within the widget portion 212, the user is able to undertake several interactive actions. For example, the user is able to change the departure date and/or the return date for the flights sought.

Responsive to the user changes, the widget potion 212 will provide the appropriate output, including available airlines, flight duration and approximate price indication. Now, it should be noted that the widget portion 212 is associated with a vertical service of Google in other words, it was specifically built for the Google flight information vertical service. It is also noted that the widget portion 212 is provided within or as part of the advertising portion 208.

Now, even though the known solution provides an improvement over the general SERP, it still lacks in many respects. One clear limitation is the widget portions 112, 212 provided as examples above have been built for specific vertical services or, in other words, are dedicated to the respective services. For example, if the user was to search for “cheap train rides from Toronto to Montreal”, the above described widget portion 112 would simply not work and the user would be presented with the general SERP listing ranked search results pertaining to the search query so submitted.

PCT patent application 2012/160567 discloses a system and method for dynamic and active search engine. A method includes displaying active resources and active search results based on monitoring, tracking, crawling, registering, subscribing, identifying active resources from one or more sources, receiving, updating, recording, logging, storing, indexing and processing said active resources and active searchable resources from one or more sources and generating, updating, sending, publishing, presenting & providing request and/or search query specific active resources or active search results to active searching user or requestor. A method enables dynamic, customize, unified active search engine, active search results, active ranking, and active advertisements based on identified, dynamic, contextual & accessible active link(s).

### SUMMARY

It is an object of the present technology to ameliorate at least some of the inconveniences present in the prior art.

According to a first broad aspect of the present technology, there is provided a method of presenting a search result page (SERP) to a user in response to a search query. The method is executable at a server. The method comprises generating an interactive snippet field on the SERP in association with a resource, the resource being responsive to the search query: allowing for a two-way communication between the interactive snippet field and the resource such that at least a portion of the interactive snippet field can be updated based on (i) a first data component received from the user via the interactive snippet field and (ii) a second data component received from the resource.

In some implementations, generating the interactive snippet field comprises generating the interactive snippet field based at least in part on a parameter pre-defined by the resource. In some implementations, the method further comprises receiving the parameter from the resource.

In some implementations, receiving the parameter is executed prior to a point of time when the user has submitted the search query. In other implementations, receiving the parameter is executed at a point of time when the user has submitted the search query. In yet further implementations, receiving is executed as part of web crawling. In yet additional implementations, receiving the parameter is executed after a point of time when the user has submitted the search query.

In some implementations, the parameter is instrumental for the server to determine how the interactive snippet field is to be displayed. In some implementations, the parameter is instrumental for the server to determine what information should be displayed within the interactive snippet field. In yet additional implementations, the parameter is instrumental for the server to determine at least a portion of at least one of: (i) what information is to be displayed within the interactive snippet field and (ii) how the interactive snippet field is to be displayed.

In some implementations, wherein the receiving comprises receiving an XML file from the resource, the XML file containing the parameter. In some implementations, the parameter is embedded into a web page associated with the resource and wherein the receiving comprises appreciating the parameter from the web page.

In some implementations, the two-way communication is established by means of an application programming interface (API). Allowing for a two-way communication between the interactive snippet field and the resource may comprise transmitting the first data component to the resource: and receiving the second data component received the resource.

In some implementations, the second data component is generated at least partially responsive to the first data component.

In some implementations, the parameter is instrumental in causing the server to generate a user interface within the interactive snippet, the user interface for enabling the user to input the first data component. In some implementations, the first data component is representative of a further refinement of the search query pertaining to the resource. In some implementations, the first data component is representative of a transaction the user is desirous of performing with the resource.

In some implementations, wherein the interactive snippet field allows the user to complete the transaction with the resource without leaving the SERP. In some implementations, the interactive snippet field allows the user to complete the transaction with the resource without accessing a web site associated with the resource.

In some implementations, the method further comprises receiving the second data component from the resource, the second data component having been generated by the resource based at least partially on the at least a portion of the first data component.

In some implementations, the first data component is representative of a transaction to be made with the resource, and wherein the interactive snippet field allows for the transaction to be executed without leaving the SERP. In some implementations, the first data component is representative of a transaction to be made with the resource, and wherein the interactive snippet field allows for the transaction to be executed without accessing a web site associated with the resource.

In some implementations, the method further comprises receiving provisioning information associated with the parameter pre-defined by the resource. In some implementations, the receiving provisioning information is executed prior to the generating. In some implementations, the method further comprises the provisioning information is the second data component.

In some implementations, the receiving provisioning information comprising presenting a provisioning web site to an operator associated with the resource. In some implementations, the operator provides provisioning information in lieu of creating interactive functionality on a website associated with the resource. In some further implementations, the operator provides provisioning information in lieu of creating a website associated with the resource.

In some implementations, the method further comprises receiving a third data component from the resource via the two-way communication, the third data component being an update to the second data component. In some implementations, the receiving the third data component is executed without receiving an action from the user. In some implementations, the receiving the third data component is executed without the user having to refresh a web page displaying the SERP. In some implementations, the receiving the third data component is executed in response to there being a change to the second data component, the change being appreciated by the resource.

In some implementations, the method further comprises appreciating a fourth data component from the user, fourth data component being an update to the first data component and wherein the receiving the third data component is executed in response appreciating the fourth data component.

In accordance with another broad aspect of the present technology, there is provided a server configured for presenting a search result page (SERP) to a user in response to a search query. The server has a transient computer usable information storage medium that stores computer executable instructions, which instructions when executed are configured to render the server operable to execute the steps of: generating an interactive snippet field on the SERP in association with a resource, the resource being responsive to the search query: allowing for a two-way communication between the interactive snippet field and the resource such that at least a portion of the interactive snippet field can be updated based on (i) a first data component received from the user via the interactive snippet field and (ii) a second data component received from the resource.

In accordance with another broad aspect of the present technology, there is provided a method of presenting a search result page (SERP) to a user in response to a search query, the method executable at an electronic device associated with the user. The method comprises displaying an interactive snippet field on the SERP in association with a resource, the resource being responsive to the search query; creating a two-way communication between the interactive snippet field and the resource such that at least a portion of the interactive snippet field can be updated based on (i) a first data component received from the user via the interactive snippet field and (ii) a second data component received from the resource.

In accordance with another broad aspect of the present technology, there is provided a method of provisioning an interactive snippet in association with a resource. The method can be executed at an electronic device (such as device similar to the electronic device 302) associated with an operator of the resource. The method comprises: (i) providing provisioning information, the provisioning information for enabling generation of an interactive snippet field on a search result page (SERP) in association with the resource, the resource being responsive to a search query; and (ii) the interactive snippet field for allowing for a two-way communication between the interactive snippet field and the resource such that at least a portion of the interactive snippet field can be updated based on (i) a first data component received from the user via the interactive snippet field and (ii) a second data component received from the resource.

In accordance with another broad aspect of the present technology, there is provided a method of operating a resource for presenting information to a user in response to a search query. The method comprises: providing provisioning information, the provisioning information for enabling generation of an interactive snippet field on a search result page (SERP) in association with the resource, the resource being responsive to a search query: defining at least one API for allowing for a two-way communication between the interactive snippet field and the resource such that at least a portion of the interactive snippet field can be updated based on (i) a first data component received from the user via the interactive snippet field and (ii) a second data component received from the resource.

In accordance with yet another broad aspect of the present technology there is provided a method of presenting a search result page (SERP) to a user in response to a search query. The method can be executable at a server. The method comprises: generating a first interactive snippet field on the SERP in association with a first resource, the first resource being responsive to the search query; generating a second interactive snippet field on the SERP in association with a second resource, the second resource being responsive to the search query: allowing for a two-way communication between the respective ones of (i) the first interactive snippet field and the first resource and (ii) the second interactive snippet field and the second resource, such that at least a portion of the respective one of the first interactive snippet field and the second interactive snippet field can be updated based on (i) a first data component received from the user via the interactive snippet field and (ii) a second data component received from the respective one of the first resource and the second resource.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running, software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.). USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as yell as other aspects and further features thereof, reference is made to the following description which is to be used in conjunction with the accompanying drawings, where:

FIG. 1 depicts a screenshot 100, the screenshot 100 depicting a SERP implemented in accordance with the known techniques.

FIG. 2 depicts a screenshot 200, the screenshot 200 depicting a SERP implemented in accordance with other known techniques.

FIG. 3 is a schematic diagram depicting a system 300, the system 300 being implemented in accordance with non-limiting embodiments of the present technology.

FIG. 4 depicts a non-limiting embodiment of a screen shot 400, the screen shot 400 depicting a SERP implemented in accordance with embodiments of the present technology.

FIG. 5 depicts a non-limiting embodiment of a screen shot 500, the screen shot 501) depicting a portion of a SERP, the portion of the SERP being implemented in accordance with another non-limiting embodiment of the present technology.

FIG. 6 depicts a non-limiting embodiment of a screen shot 600, the screen shot 600 depicting the portion of the SERP of FIG. 5 implemented to another non-limiting embodiment of the present technology.

FIG. 7 depicts a non-limiting embodiment of a screen shot 700, the screen shot 700 depicting the portion of the SERP of FIG. 5, implemented to another non-limiting embodiment of the present technology.

FIG. 8 depicts a non-limiting embodiment of a screen shot 800, the screen shot 800 depicting the portion of the SERP of FIG. 5, implemented to another non-limiting embodiment of the present technology.

FIG. 9 depicts a non-limiting embodiment of a screen shot 900, the screen shot 900 depicting the portion of the SERP of FIG. 5, implemented to another non-limiting embodiment of the present technology.

FIG. 10 depicts a block diagram of a method 1000, the method 1000 being implemented in accordance with non-limiting embodiments of the present technology within the system 300 of FIG. 3.

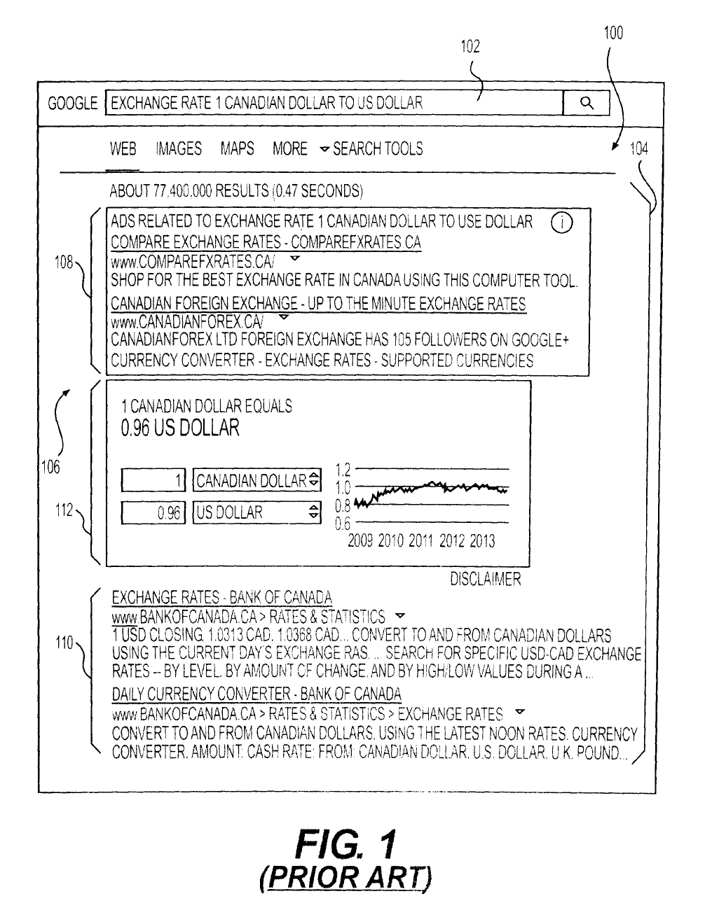

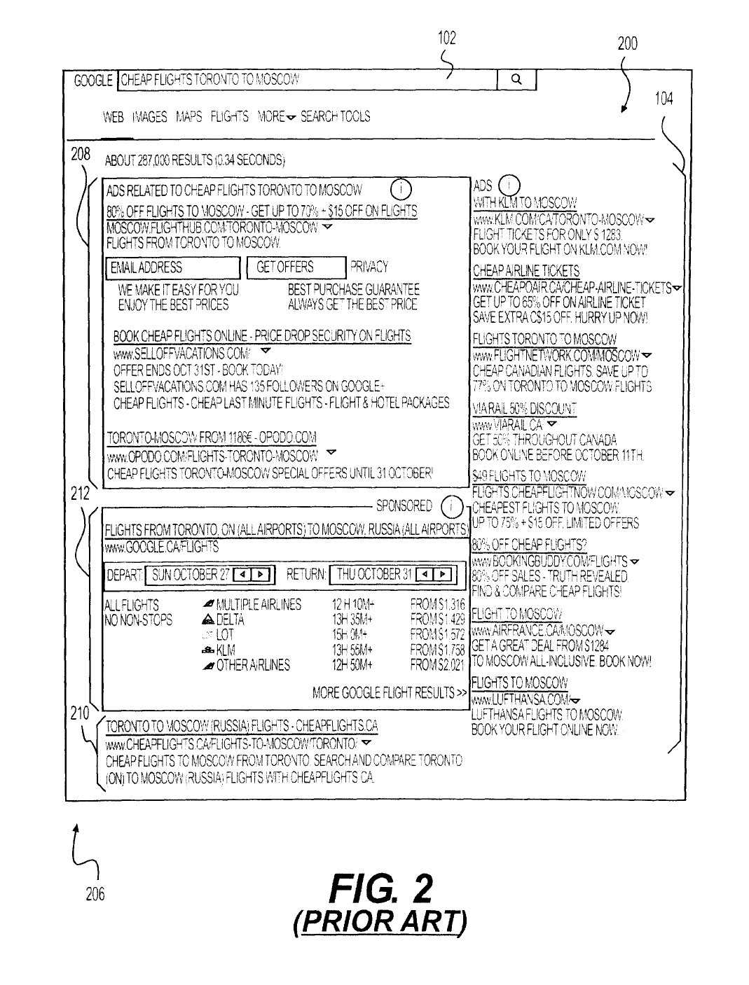

### DETAILED DESCRIPTION

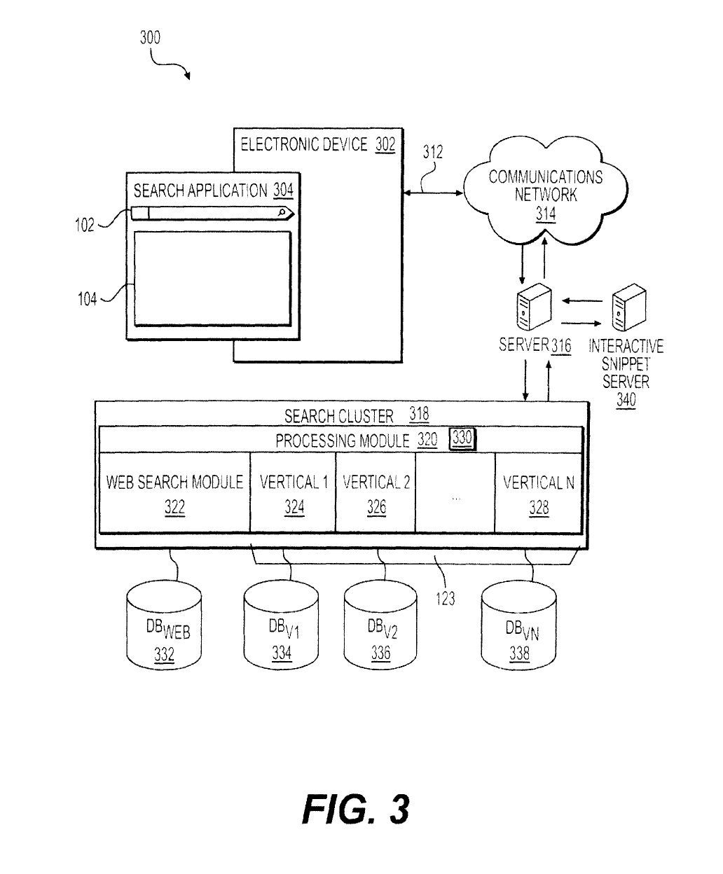

Referring to FIG. 3, there is shown a schematic diagram of a system 300, the system 300 being suitable for implementing non-limiting embodiments of the present technology. It is to be expressly understood that the system 300 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 300 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 300 may provide in certain instances simple implementations of the present technology, and that where such is the case they have been presented in this manner as an aid to understanding. As persons skilled in the art would understand, various implementations of the present technology may be of a greater complexity.

The system 300 comprises an electronic device 302. The electronic device 302 is typically associated with a user (not depicted) and, as such, can sometimes be referred to as a “client device”. It should be noted that the fact that the electronic device 302 is associated with the user does not need to suggest or imply any mode of operation—such as a need to log in, a need to be registered or the like.

The implementation of the electronic device 302 is not particularly limited, but as an example, the electronic device 302 may be implemented as a personal computer (desktops, laptops, netbooks, etc.), a wireless communication device (a cell phone, a smartphone, a tablet and the like), as well as network equipment (a router, a switch, or a gateway). The electronic device 302 comprises hardware and/or software and/or firmware (or a combination thereof), as is known in the art, to execute a search application 304. Generally speaking, the purpose of the search application 304 is to enable the user (not depicted) to execute a search, such as the above mentioned web search using the above-mentioned search engine. To that end, the search application comprises the aforementioned query interface 102 and search results interface 104.

How the search application 304 is implemented is not particularly limited. One example of the search application 304 may be embodied in a user accessing a web site associated with a search engine to access the search application 304. For example, the search application can be accessed by typing in an URL associated with Yandex search engine at www.yandex.ru. It should be expressly understood that the search application 304 can be accessed using any other commercially available or proprietary search engine.

In alternative non-limiting embodiments of the present technology, the search application 304 may be implemented as a browser application on a portable device (such as a wireless communication device). For example (but not limited) to those implementations, where the electronic device 302 is implemented as a portable device, such as for example, Samsung™ Galaxy™ SIII, the electronic device may be executing a Yandex browser application. It should be expressly understood that any other commercially available or proprietary browser application can be used for implementing non-limiting embodiments of the present technology.

The electronic device 302 is coupled to a communications network 314 via a communication link 312. In some non-limiting embodiments of the present technology, the communications network 314 can be implemented as the Internet. In other embodiments of the present technology, the communications network 314 can be implemented differently, such as any wide-area communications network, local-area communications network, a private communications network and the like.

How the communication link 312 is implemented is not particularly limited and will depend on how the electronic device 302 is implemented. Merely as an example and not as a limitation, in those embodiments of the present technology where the electronic device 302 is implemented as a wireless communication device (such as a smart-phone), the communicated link 102 can be implemented as a wireless communication link (such as but not limited to, a 3G communications network link, a 4 G communications network link, a Wireless Fidelity, or WiFi® for short. Bluetooth® and the like). In those examples, where the electronic device 302 is implemented as a notebook computer, the communication link can be either wireless (such as the Wireless Fidelity, or WiFi® for short, Bluetooth® or the like) or wired (such as an Ethernet based connection).

It should be expressly understood that implementations for the electronic device 302, the communication link 312 and the communications network 314 are provided for illustration purposes only. As such, those skilled in the art will easily appreciate other specific implementational details for the electronic device 302, the communication link 312 and the communications network 314. As such, by no means, examples provided herein above are meant to limit the scope of the present technology.

Also coupled to the communications network is a server 316. The server 316 can be implemented as a conventional computer server. In an example of an embodiment of the present technology, the server 316 can be implemented as a Dell™ PowerEdge™ Server running the Microsoft™ Windows Server™ operating system. Needless to say, the server 316 can be implemented in any other suitable hardware and/or software and/or firmware or a combination thereof. In the depicted non-limiting embodiment of present technology, the server 316 is a single server. In alternative non-limiting embodiments of the present technology, the functionality of the server 316 may be distributed and may be implemented via multiple servers.

The server 316 is communicatively coupled (or otherwise has access) to a search cluster 318. The general purpose of the search cluster 318 is to perform searches in response to the user queries inputted via the query interface 102 and to output search results to be presented to the user using the search results interface 104. What follows is a description of one non-limiting embodiment of the implementation for the search cluster 318. However, it should be understood that there is a number of alternative non-limiting implementations of the search cluster 318 possible. It should be also expressly understood that in order to simplify the description presented herein below, the configuration of the search cluster 318 has been greatly simplified. It is believed that those skilled in the art will be able to appreciate implementational details for the search cluster 318 and for components thereof that may have been omitted for the purposes of simplification of the description.

Generally speaking the purpose of the search cluster 318 is to (i) conduct searches (details will be explained herein below); (ii) execute analysis of search results and perform ranking of search results; (iii) group results and compile the search result page (SERP) to be outputted to the electronic device 302. How the search cluster 318 is configured to execute searches is not particularly limited. Those skilled in the art will appreciate several ways and means to execute the search using the search cluster 318 and as such, several structural components of the search cluster 318 will only be described at a high level.

In some non-limiting embodiments of the present technology, the search cluster 318 comprises a processing module 320. The processing module 320 can execute several searches, including but not limited to, a general search and a vertical search. To that end, the processing module 320 comprises (or has access to) a web search module 322. The web search module 322 is configured to perform general web searches, as is known to those of skill in the art.

In some non-limiting embodiments of the present technology, processing module 320 can execute what is known as a multi-level search. These non-limiting embodiments can be implemented, for example, to increase the speed of the search and to obtain more relevant search results. In some non-limiting embodiments of the present technology, the web search module 322 can be responsible for executing the multi-level search.

To that end, the web search module 322 can execute the top level meta search, as will be discussed in greater detail herein below. The web search module 322 may also have access to a database DB_{WEB} 332, which database DB_{WEB} 332 may be accessed by the web search module 322 to conduct a middle level meta search and a bottom level search. Even though the database DB_{WEB} 332 is depicted as a single entity, in some non-limiting embodiments of the present technology, the database DB_{WEB} 332 can be implemented in a distributed manner, for example as a dedicated database for each of the middle level meta search and the bottom level search.

Also, even though the web search module 322 is depicted as a single entity, in alternative non-limiting embodiments of the present technology the web search module 322 may also be implemented in a distributed manner. For example, each of the distributed implementations of the web search modules 322 may be dedicated to search queries originating from a particular geographical region. In those non-limiting, embodiments of the present technology, the processing module 320 may determine a location and/or an IP address associated with the electronic device 302 associated with the user who is submitting the search query. Based on the so-determined location and/or the IP address of the electronic device 302, the processing module 320 may forward the search query to one of the distributed web search modules 322 to perform the top level meta search.

The web search module 322 may also forward a request to the database DB_{WEB} 332 to perform the middle level meta search and the bottom level search. In some non-limiting embodiments of the present technology, the database DB_{WEB} 332 may have a portion (or a separate database) dedicated to the middle level meta search (for example, having a repository of frequently asked questions). The identification of the portion (or a separate database) of the database DB_{WEB} 332 responsible for the middle level meta search may be executed by the database DB_{WEB} 332 based on a so-called “CRC-code”. The portion (or a separate database) of the database DB_{WEB} 332 responsible for the middle level meta search may send a given generated query to a portion (or a separate database) of the database DB_{WEB} 332 responsible for the bottom level search.

However, in some non-limiting embodiments of the present technology, where the search query is already saved in cache of the portion (or the separate server) of the database DB_{WEB} 332 as part of the middle level meta search, the step of transmitting the query to the portion (or the separate database) of the database DB_{WEB} 332 responsible for the bottom level search may be omitted altogether. Naturally, in alternative embodiments of the present technology, even if the search query is already saved in cache of the portion (or the separate server) of the database DB_{WEB} 332 as part of the middle level meta search, the step of transmitting the query to the portion (or the separate database) of the database DB_{WEB} 332 responsible for the bottom level search may still be performed.

The processing module 320 further comprises (or has access to) a plurality of vertical search modules 323. In the depicted non-limiting embodiment, the plurality of vertical search modules includes a vertical 1 module 324, a vertical 2 module 326 and a vertical N module 328. It should be expressly understood that the number of modules within the plurality of vertical search modules 323 is not meant to be a limitation of embodiments of the present technology.

Merely for the purposes of ease of illustration, it shall be assumed that the vertical 1 module 324 is implemented as a vertical search domain for searching maps and other geographical information. As such, it can be said that the vertical 1 module 324 implements a map vertical search engine or, simply, a map service.

Furthermore, it shall be assumed that the vertical 2 module 326 is implemented as a vertical search module for searching images. As such, it can be said that the vertical 2 module 326 implements an images vertical search domain or, simply, an image service. For the various examples to be provided herein below, it shall be assumed, selectively, that the vertical N search module 328 can implement one of sports news, movies, weather, translation, wiki or movia the ater services. It should be expressly understood that a number of additional or different services can be implemented as part of the plurality of vertical search modules 323.

In some non-limiting embodiments of the present technology, any given one of the plurality of vertical search modules 323 comprises or has access to one or more databases. These one or more databases host data associated with the particular service implemented by the given one of the plurality of vertical search modules 323.

To that extent, the vertical 1 module 324 has access to a database DB_{V1} 334. Recalling that the vertical 1 module 324 implements a map service, the database DB_{V1} 334 contains information related to geographical location of various objects and the associated maps. The vertical 2 module 326 has access to a database DB_{V2} 336. Recalling that the vertical 2 module 326 implements an image service, the database DB_{V2} 336 can host a repository of various images. By the same token, the vertical N module 328 has access to a database DB_{VN} 338. Recalling that the vertical N module 328 implements selectively one of sports news, movies, weather, translation or movia the ater services, the database DB_{VN} 338 can host a repository of data associated with the respective selective service.

Additionally or optionally and, as known to those skilled in the art, the one or more databases (such as the database DB_{V1} 334, DB_{V2} 336 and DB_{VN} 338) may be segregated into one or more separate databases. These segregated databases may be portions of the same physical database (such as the database DB_{V1} 334, database DB_{V2} 336 and database DB_{VN} 338) or may be implemented as separate physical entities. For example, one database within, let's say, the database DB_{V2} 336 could host the most popular/most frequently requested images in a given category, while another database within the database DB_{V2} 336 could host all the images available within the image service. Needless to say, the above has been provided as an illustration only and several additional possibilities exist for implementing embodiments of the present technology. Also, as is known to those of skill in the art, the search cluster 118 or the server 116 may execute a crawler algorithm which algorithm causes the search cluster 118 or the server to “crawl” the Internet and index visited web sites into one or more of the databases (such as the database DB_{V1} 334, DB_{V2} 336 and DB_{VN} 338).

Furthermore, it is possible that some of the plurality of vertical search modules 323 may not implement a separate database. This is particularly true, but is not limited to, for example, the vertical N module 328 implementing a weather service. In this example, the vertical N module 328 implementing the weather service may not have a dedicated database, but may rather have access to a service widget repository 330. The service widget repository 330 may be implemented as data repository for one or more widget applications, as will be described in greater detail here below.

Each of the plurality of vertical search modules 323 is configured to perform vertical searches within the respective databases (i.e. database DB_{V1} 334, database DB_{V2} 336 and database DB_{VN} 338). However, it should be noted that the search capabilities of the plurality of vertical search modules 323 are not limited to searching the respective databases (i.e. database DB_{V1} 334, database DB_{V2} 336 and database DB_{VN} 338). As such, the plurality of vertical search modules 323 may perform other searches, as the need may be.

Also, for the purposes of the description presented herein, the term “vertical” (as in vertical search or in vertical search domain) is meant to connote a search performed on a subset of a larger set of data, the subset having been grouped pursuant to an attribute of data. For example, to the extent that the vertical 2 module 326 implements an image service, the vertical 2 module 326 searches a subset (i.e. images) of the set of data (i.e. all the data potentially available for searching), the subset of data being stored in the database DB_{V2} 336.

Merely for the purposes of simplifying the description to be presented herein, only a high level description of one approach to executing a search by the search cluster 318 will be presented herein below. It is expected that those skilled in the art will be able to configure the search cluster 318 in any number of known ways without undue experimentation or burden.

As has been mentioned above, in some non-limiting embodiments of the present technology, the processing module 320 can be configured to execute a search in a multi-level meta fashion. In some non-limiting embodiments of the present technology, the processing module 320 includes an http-interface (not depicted) for receiving the search request from the server 316.

When the processing module 320 receives the search query from the server 316, it sends the search query to the web search module 322. As has been alluded to above, in some non-limiting embodiments of the present technology, the sending of the search request to the web search module 322 may be based on the location and/or IP address associated with the electronic device 302, as may be determined by the processing module 320. The web search module 322 performs a search, which in some non-limiting embodiments of the present technology may include a multi-level search. To that extent, the web search module 322 executes some or all of the top level meta search, middle level middle search and the bottom level search.

In parallel or in sequence, the processing module 320 also transmits the search query to the plurality of vertical search modules 323 for performing, the respective vertical searches. The responses from all the search sources (the plurality of vertical search modules 323 and the web search module 322, which may include the bottom level search, the middle level meta search and the top level meta search) are received and amalgamated by the processing module 320.

The processing module 320 then executes a ranking function to generate a ranked search results set. In other words, the processing module 320 ranks the search results by their relevancy to the search query submitted by the user. As those skilled in the art will appreciate, relevancy within this description shall mean how responsive a given search result is to the user query.

Those skilled in the art will appreciate various techniques available for ranking search results. Just as an example and not as a limitation, some of the known techniques for ranking search results by relevancy are based on some or all of: (i) how popular a given search query or a response thereto is in either the plurality of vertical search modules 323 or in the bottom level search (or any other level of the multi level meta search): (ii) how many results have been returned by either the plurality of vertical search modules 323 or in the bottom level search (or any other level of the multi level meta search): (iii) whether the search query contains any determinative terms (such as “images”, “movies”, “weather” or the like), (iv) how often a particular search query is typically used with determinative terms by other users; and (v) how often other uses performing a similar search have selected a particular resource or a particular vertical search results when results were presented using the standard SERP.

Within this description, the term “determinative term” shall mean a word or a string of words indicative of the fact that a given search result is more likely to have the most relevant response to the user search query. For example, if the search query contains the term “images” it can be determined, by the processing module 320, that the vertical 2 module 326, being implemented as an image service, is likely to be the service that contains the most relevant results to the user query. Needless to say, only a sub set of these, or these combined to others or any combination of other factors my be taken into account when raking the search results for relevancy.

The search cluster 318 is then configured to transmit ranked search results to the server 316.

It should be noted that the above described architecture of system 300 of FIG. 3 has been depicted as an example only. Other non-limiting embodiments for the architecture of FIG. 3 are possible and will become apparent to those of skill in the art having benefit of the present disclosure. For example, the plurality of vertical search modules 323 may be accessed by the server 316 independently from the search cluster 318 and, therefore, may be located on a server other than the search cluster 318.

According to embodiments of the present technology, the system 300 further includes an interactive snippet server 340. The interactive snippet server 340 is depicted in a two-way communication with the server 116. However, in alternative non-limiting embodiments, the two-way communication between the interactive snippet server 34)) and the server 116 may be done via the communications network 114. In yet additional embodiments, the functionality of the interactive snippet server 340 can be executed as part of the server 116 or the search cluster 318.

Generally speaking, the interactive snippet server 340 comprises non-transient computer usable information storage medium that stores computer executable instructions, which instructions when executed are configured to render the interactive snippet server 340 operable to execute interactive snippets in accordance with embodiments of the present technology.

More specifically, the interactive snippet server 340 enables directly or indirectly: (i) provisioning of the interactive snippets; (ii) displaying of the interactive snippets as part of SERP in association with one or more of the resources displayed in the SERP: (iii) executing a two-way communication between the user and the one or more of the resources via the interactive snippet.

We will now explore each of these functions of the interactive snippet server 340 in greater detail.

Scenario 1.

In order to provide illustrations to the various methods and techniques described herein, the following first example scenario will be used. It will be assumed that there is a web site www.cars.com, which web site caters to listing of new and used cars. It will be further assumed that an operator and/or owner of the web site would like to have an interactive snippet presented in association therewith when the web site is listed on the SERP. It shall be further assumed that it is desirable that the interactive snippet associated with this resource should have an interactive search functionality based on one or more make, model, state, certification status, year of make and the ZIP code.

Scenario 2.

In order to provide illustrations to the various methods and techniques described herein, the following second example scenario will be used. It will be assumed that there is a web site www.spacetaxi.ru, which web site is associated with a taxi company. It will be further assumed that an operator and/or owner of the web site would like to have an interactive snippet presented in association therewith when the web site is listed on the SERP. It shall be further assumed that the interactive snippet associated with this resource should have an interactive search functionality, which allows to perform one or more of: provide information as to how many available cars are out there, provide an indication of a wait time for the taxi, provide an indication of an approximate cost of service, allow the user to book a taxi based one or more parameters of pick up location, destination location, client name, client contact information, pick up time, etc.

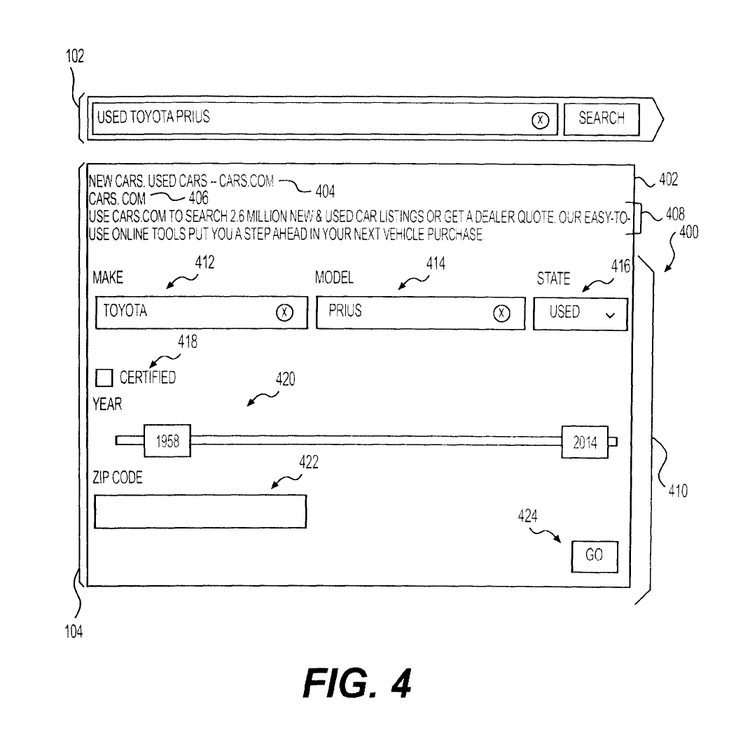

Using the above-mentioned example Scenario 1, the provisioning of the interactive snippet will be described. Reference is now made to FIG. 4. FIG. 4 depicts a non-limiting embodiment of a screen shot 400. Within the screen shot 400, there is provided the aforementioned query interface 102 and the search results interface 104. The query interface 102 can be part of the command line of a search browser, a search line of a search engine or a combined command/search line. Within the query interface 102 a query can be inserted, such as used “Used Toyota Prius”.

The search results interface 104 is configured to show a plurality of search results, only one of which is depicted in FIG. 4 for simplicity. Within FIG. 4, the search results interface 104 includes a search result 402, which search result 402 is implemented in accordance with non-limiting embodiments of the present technology.

The search result 402 can be implemented as an interactive snippet. To that end, the search result 402 includes a title field 404. The title field 404 is for providing some or all of: title of the resource. URL, of the resource, etc. The search result 402 further includes an address field 406. The address field 406 displays the URL of the resource. In some embodiments, the address field 406 can be omitted.

The search result 402 further includes a static snippet field 408. The static snippet field 408 provides a summary of the resource to enable the user performing the search to appreciate what the resource is about. The search result 402 further includes an interactive snippet field 410. Generally speaking, the interactive snippet field 410 allows for a two-way interaction between the user and the resource associated with the interactive snippet field 410, via the interactive snippet field 410 without leaving the SERP where the interactive snippet field 410 is displayed.

Flow the form factor and content of the interactive snippet field 410 is generated will be explained momentarily. However and generally speaking, the form factor and content of the interactive snippet field 410 will depend, at least in part, on the content of the resource with which the interactive snippet field 410 is associated with.

In some embodiments of the present technology, the interactive snippet field 410 can be generated by the server 116. In additional embodiments of the present technology, the interactive snippet field 410 can be generated based at least in part on information provided by the resource associated with the search result 104. In yet additional embodiments of the present technology, the interactive snippet field 410 can be generated and/or updated based at least in part on information provided by the resource associated with the search result 104 and interaction between the user and the interactive snippet field 410.

Within the illustrated embodiment, the interactive snippet field 410 comprises a make drop down field 412, a model drop down field 414, a state drop down field 416, a certified status check box 418, a year sliding scale field 420, a zip code entry field 422 and a go button 424.

The make drop down field 412 can be used to select the make of the car to further filter search results within the SERP, the search results coming from the resource associated with the interactive snippet field 410. The make drop down field 412 has been pre-populated with “Toyota”, based on the query received within the search interface 402.

The model drop down field 414 can be used to select the model of the car to further filter search results within the SERP, the search results coming from the resource associated with the interactive snippet field 410. The model drop down field 414 has been pre-populated with “Prius”, based on the query received within the search interface 402.

In some embodiments of the present technology, the content of the selections available within the model drop down field 414 will depend on the selection made within the make drop down field 412 (i.e. be in a master-slave relationship). For example, if the user has selected “Toyota” within the make drop down field 412, choices available within the model drop down field 414 would include “Prius”, “Corolla”, “RAV4” and the like. Naturally, if the user selects “Ford” (or any other make of the car) within the make drop down field 412, choices available within the model drop down field 414 would be different.

The state drop down field 416 allows the user to select the state of the car she is searching for, such as “new”, “used”, etc. The certified status check box 418 allows the user to select the certification status of the car she is searching for.

The year sliding scale interface 420 allows the user to select the year of make or a range of years of make of the car she is searching for. Even though within the illustrated embodiment, the year sliding scale interface 420 allows the user to select both ends of the year range, in alternative embodiments, the year sliding scale interface 420 can be used to select a single value for one of the ends of the yea range (for example, from 1999 to present or the other way round, prior to 1999).

The zip code entry field 422 allows the user to enter a zip code (or another suitable postal identifier) of the area where the user is searching for the car. Finally, the go button 424 allows to submit the content of the interactive snippet field 410 (which in this case can be thought of search results filter settings). It should be noted that even though the go button 424 is described as an actual button, it can also take a form of a link or any other form factor.

As has been mentioned above, in some embodiments of the present technology, the information displayed within the interactive snippet field 410 can be based on a data element provided by the source of the search result 104 (such as a web master associated with the web site hosting the resource with the search result displayed within the search result 104). In some embodiments, the webmaster accesses a web site associated with the provider of the interactive snippet server 340 and enters an interactive snippet provisioning page. Within the interactive snippet provisioning page the webmaster can provision the layout and/or the content of the interactive snippet field 410. In some embodiments, the webmaster can also provision the layout and/or the content of the static snippet field 408.

More specifically, for the static snippet field 408, the webmaster can submit which blurb is displayed to the user on SERP. For the interactive snippet field 410, the webmaster can provision which fields (i.e. one or more of the make drop down field 412, the model drop down field 414, the state drop down field 416, the certified status check box 418, the year sliding scale field 420, the zip code entry field 422 and the go button 424 or other fields) are displayed within the interactive snippet field 410. Furthermore, for the interactive snippet field 410, the webmaster can provision how the fields (i.e. one or more of the make drop down field 412, the model drop down field 414, the state drop down field 416, the certified status check box 418, the year sliding scale field 420, the zip code entry field 422 and the go button 424 or other fields) are displayed within the interactive snippet field 410.

For some of the fields, the webmaster can further provision predefined values, ranges, acceptable entry values and the like. For example, the web master can provision which values are displayed in the drop down menus or the minimum and maximum values for the sliding scales.

In some embodiments of the present technology, the provisioning information is stored with the web page itself. For example, the provisioning information can be stored within the HTML tag “Form”. This is applicable, but is not limited to, those embodiments where the provisioning information pertains to a relatively simple form. In some embodiments of the present technology, the description of provisioning information can be done pursuant to standards schema.org or Open graph.

It should be noted that in some embodiments of the present technology, an operator of the interactive snippet server 340 can pre-define certain rules for the presentation, lay out or content of the interactive snippet field 410. Some examples of the rules may include but are not limited to: syntaxes for describing the interactive snippet field 410. “height” of the interactive snippet field 410, number of fields within the interactive snippet field 410, etc. Alternatively, the operator associated with the interactive snippet server 340 may preview and/or moderate the content or the layout of the interactive snippet field 410.

In other embodiments of the present technology, the provisioning information is stored in a file separate from the file storing the content of the web page itself. In some embodiments, the provisioning information is stored in an XML file.

As will be recalled, the interactive snippet field 410 allows for a two way communication between the user and the resource via the interactive snippet field 410. To that end, the resource associated with the search result 104 (i.e. the web site hosting www.cars.com) implements one or more APIs for allowing the two way communication. The type of data exchanged via the APIs is not particularly limited and will depend on the specific embodiment being implemented. In some embodiments, the API is used to upload information from the resource into the interactive snippet field 410. In alternative embodiments, the API is used to transmit a user selection from the interactive snippet field 410 to the resource and to download information from the resource to the interactive snippet field 410, the downloaded information being in response to the user selection.

To illustrate the above, in some embodiments of the present technology, the interactive snippet field 410 allows the user to filter results information available on the resource via the interactive snippet field 410 without leaving the SERP. Using the above-referenced Scenario 1, the user has entered a search “used toyota prius” into the query interface 102. In response thereto, the server 116, in coordination with the interactive snippet server 340, has caused the user to see the SERP including the search result 104 associated with the www.cars.com web site.

Within the search result 104, the user is presented with the interactive snippet field 410, the interactive snippet field 410 being based at least partially on the information provided by the resource associated with the interactive snippet field 410 (and not generated solely by the server 316 associated with the search engine, for example). By interacting with the interactive snippet field 410, the user can provide a data component, the data component representative of the user responses entered into one or more fields of the interactive snippet field 410 (i.e. one or more of the make drop down field 412, the model drop down field 414, the state drop down field 416, the certified status check box 418, the year sliding scale field 420, the zip code entry field 422 and the go button 424 or other fields).

Recalling that there is a two-way communication session established, when the user clicks go button 424, user selection is transmitted from the interactive snippet field 410 towards the resource associated with the interactive snippet field 410. The transmission can be executed, for example, via the above-described APIs.

The transmitted data is the first data component provided by the user by means of interaction with the interactive snippet field 410. In response to receiving the first data component, the server 116 generates a response thereto. Continuing with our example of a filter, the response to the first data component can be a filtered list of search results from the resource (in this example, a filtered list of cars meeting the filter parameters provided by the user using the interactive snippet field 410). In some embodiments of the present invention, the server 116 transmits a second data component representing the filtered search results to the electronic device 302 and the electronic device 302 displays the results of the filtered search right on the SERP. In alternative embodiments, the electronic device 302 can cause a display of a separate window or a separate tab showing the results contained within the second data component (the separate window or tab can be a pop window, a drop down window and the like).

Now, the above has illustrated how the interactive snippet field 410 is updated on the basis of (i) a first data component received based on the interaction of the user with the interactive snippet field 410 and (ii) a second data component received from the resource associated with the search result 402. In some embodiments, the second data component is generated in response to the first data component.

In alternative embodiments, the second data component is independent from the first data component. Generally speaking, the second data component originating from the resource can take any form (including the above-described XML file containing data for the lay out and/or of the content of the interactive snippet field 410) and the first data component can take form of any user input into the interactive snippet field 410. Therefore and simply put, the interactive snippet field 410 can be updated on any combination of the data received from the resource and from the user (in any order, for that matter).

The extent of the updates of the interactive snippet field 410 can vary from one embodiment to the other. Scenario 2 will be used to illustrate the various degrees to which the interactive snippet field 410 can be updated.

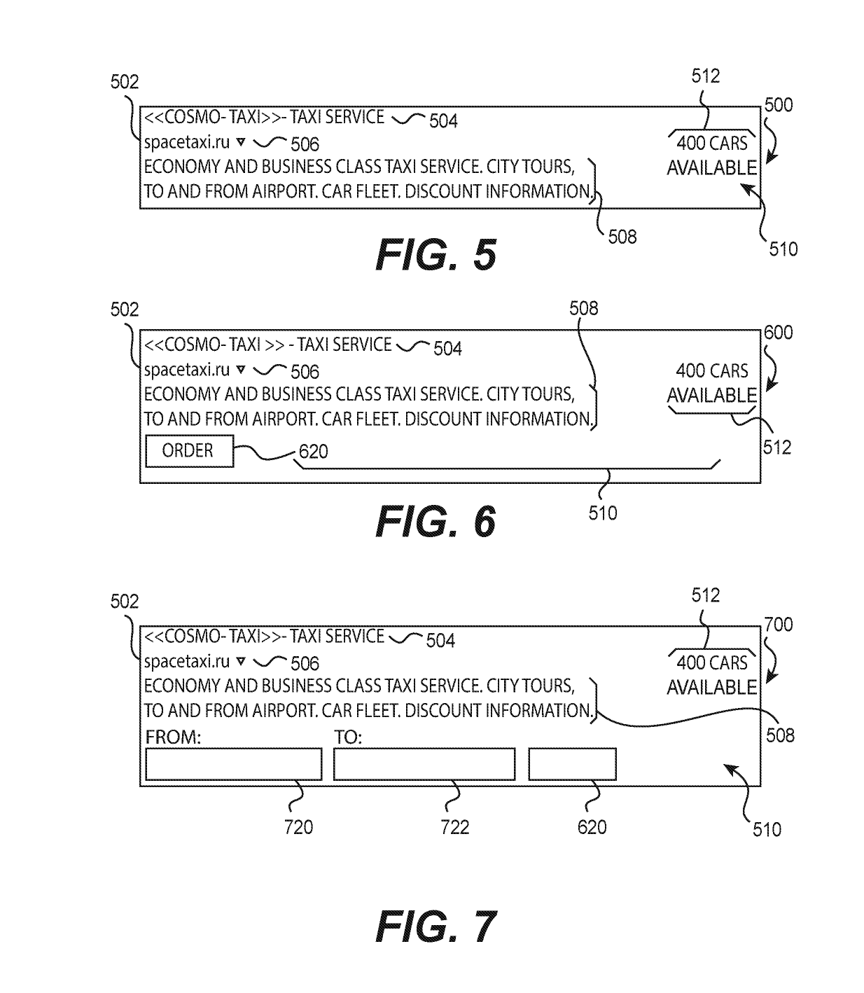

With reference to FIG. 5, a non-limiting embodiment of a screen shot 500 is depicted. The screen shot 500 depicts a portion of a SERP, the portion of the SERP being a search result 502. The search result 502 can be one of a plurality of search results (not depicted), the plurality of search results having been generated in response to a search query. For the purposes of this example, the search query may have been “Taxi online booking—Moscow”.

The search result 502 includes a title field 504. The title field 404 is for providing some or all of: title of the resource, brief description, etc. The search result 502 further includes an address field 506. The address field 506 can display the URL of the resource. In some embodiments, the address field 506 can be omitted.

The search result 402 further includes a static snippet field 508. The static snippet field 508 provides a summary of the resource to enable the user performing the search to appreciate what the resource is about and whether or not it is relevant for what the user has been looking for.

The search result 502 further includes an interactive snippet field 510. Generally speaking, the interactive snippet field 510 allows for a two-way interaction between the user and the resource associated with the interactive snippet field 510, via the interactive snippet field 510 without leaving the SERP where the interactive snippet field 510 is displayed. Additionally or alternatively, the interactive snippet field 510 allows for updating of information contained within the interactive field 510 with the updated information from the resource associated with the search result 402 substantially in real time. This real time updating occurs without leaving the SERP hosting the search result 402 and without the need to refresh the page.

As has been explained above in respect to the interactive snippet field 410, the layout and/or the content of the interactive snippet field 510 can be generated based on the information provided from the resource associated with the search result 502. For example, by accessing the aforementioned interactive snippet provisioning page the webmaster can provision the layout and/or the content of the interactive snippet field 510. In some embodiments, the webmaster can also provision the layout and/or the content of the static snippet field 508. As such, all the description provided above in respect to provisioning of the interactive snippet field 410 will apply mutatis mutandis to the provisioning of the interactive snippet field 510.

In yet alternative embodiments, some or all of the layout and/or content of the static snippet field 508 or the interactive snippet field 510 can be generated by the server 316 in a manner known in the art.

The interactive snippet field 510 can include a current availability field 512. Within the illustrated embodiment, the current availability field 512 displays the number of taxis currently available. Recalling that the interactive snippet field 510 can implement a two way communication with the resource, the data for the current availability field 512 can be obtained, in real time, from the resource associated with the search result 502.

It should be noted that the current availability field 512 is just on example of a user interface defined within the interactive snippet field 510. Generally speaking, the user interface defined within the interactive snippet field 510 enables the interactive snippet field 510 to display to the user information representative of the second data element i.e. information received from the resource associated with the search result 502.

With reference to FIG. 6, a screen shot 600 is depicted, the screenshot 600 depicting another embodiment of the interactive snippet field 510. Within this embodiment, the interactive snippet field 510 includes the current availability field 512 and an order button 620. By pressing the order button 620, the user can indicate her desire to book a taxi using the interactive snippet field 510 without leaving SERP that hosts search result 502. It should be noted that even though the order button 620 is described as an actual button, it can also take a form of a link or any other form factor.

With reference to FIG. 7, a screen shot 700 is depicted, the screen shot 700 depicting another embodiment of the interactive snippet 510. Within this embodiment, the interactive snippet field 510 includes the current availability field 512, the order button 620 and a “from” field 720 (denoted as “ [symbol] ” in the Figures) and a “to” field 722 (denoted as “ [symbol] ” in the Figures). By interacting with the “from” field 720 and the “to” field 722, the user is able to provide a first data element in the form of variables representative of the start destination and the finish destination, respectively. By pressing the order button 620, the user can indicate her desire to book a taxi using the interactive snippet field 510 without leaving SERP that hosts search result 502 using the information provided in the “from” field 720 and the “to” field 722.

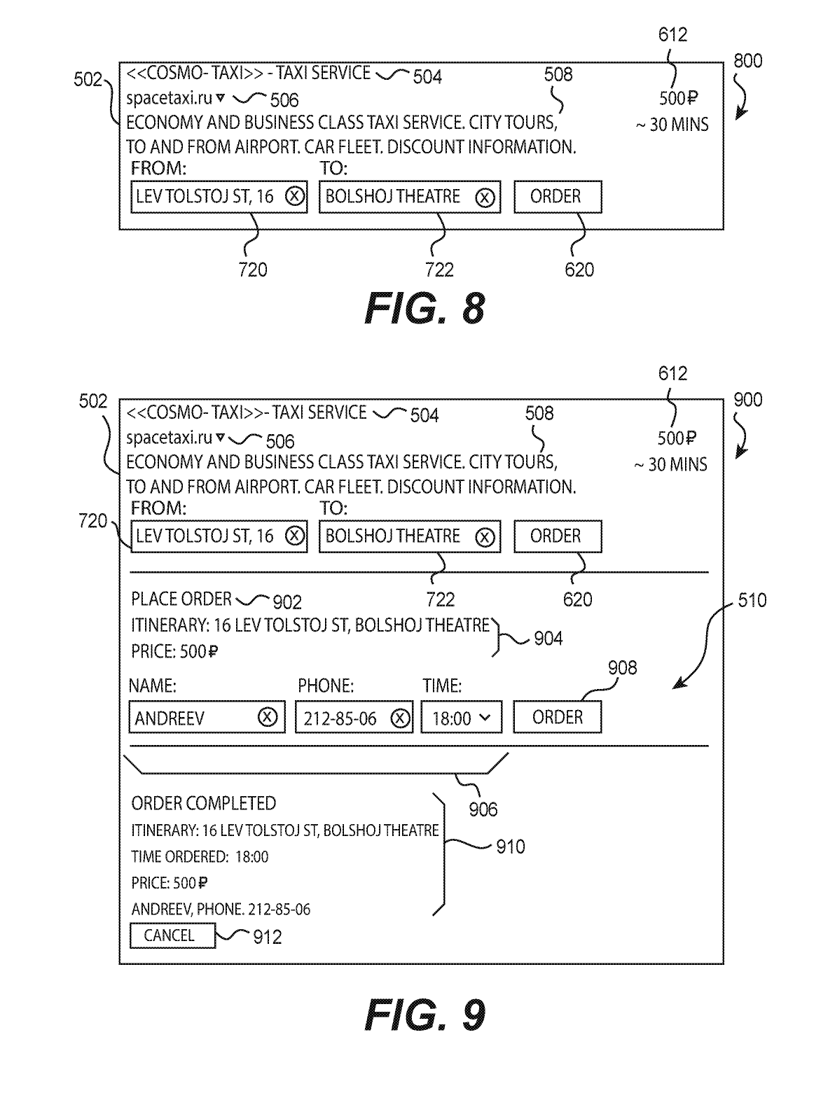

Now, recalling that the interactive snippet field 510 implements a two way communication with the resource associated with the search result 502, how the interactive snippet field 510 deals with the first data component is not particularly limited. For example, with reference to FIG. 8, there is depicted a screen shot 800, the screen shot 800 depicting the interactive snippet 510 of FIG. 7 with information having been filled in by the user into the “from” field 720 and the “to” field 722. More specifically, within the illustration of FIG. 8, the user has entered “Lev Tolstoj Street, 16” into the “from” field 720 (“ [symbol] [symbol] , 16” in Russian) and “The Bolshoj Theater” as into the “to” field 722 (“ [symbol] [symbol] ” in Russian).

It should be noted that the current availability field 512 has been replaced by a trip details field 612. In alternative embodiments, the trip details field 612 can be displayed in addition to the current availability field 512. Within this example the trip detail field 612 contains information regarding the approximate cost and the approximate time associated with a taxi trip between the origin and the destination as inputted by the user. The information for the trip detail field 612 can be populated as follows. The interactive snippet field 510 captures information provided by the user into the “from” field 720 and the “to” field 722 and transmits the first data component containing the captured information to the resource using the aforementioned APIs.

In response to the receipt of the first data element, the resource generates information that is responsive to the information contained in the first data element. Within the present example, the generated data is the indication of the approximate cost and the approximate duration of the taxi ride between the two points. The resource then compiles a second data element containing such generated information and transmits the second data element to the interactive snippet field 510. In some embodiments, the transmission of the second data element is done via the API.

Upon the receipt of the second data element, the interactive snippet field 510 changes the current availability field 512 with the trip detail field 612. Accordingly, it can be said that the interactive snippet field 510, and namely the trip detail field 612, has been generated based on the first data element that was based on interaction of the user with the interactive snippet field 510 and the second data element received from the resource that is associated with the search result 502.

In some embodiments, the change from the current availability field 512 to the trip detail field 612 is executed upon user actuating the order button 620. In alterative embodiments, the change from the current availability field 512 to the trip detail field 612 can be executed automatically. For example, the change from the current availability field 512 to the trip detail field 612 can be executed upon user completing the “from” field 720 and the “to” field 722 or portions thereof.

In some embodiments, the interactive snippet field 510 can enable the user to make the reservation without leaving the SERP that hosts the search result 502. For example and with reference to FIG. 9, there is depicted a screen shot 900, the screen shot 900 depicting the interactive snippet 510 of FIG. 7 and FIG. 8 with information having been filled in by the user into the “from” field 720 and the “to” field 722.

Furthermore, the interactive snippet field 510 has been updated with additional fields that can enable the user to book the service of the taxi from the resource associated with the search result 502 without leaving the SERP. The interactive snippet field 510 can be updated, for example, in response to the user actuating the order button 620. In alterative embodiments, the interactive snippet field 510 can be updated automatically. For example, the change to the interactive snippet field 510 can be executed upon user completing the “from” field 720 and the “to” field 722 or portions thereof.

In some embodiments, the change to the interactive snippet field 510 can be executed before, concurrently or after the above-described change from the current availability field 512 to the trip detail field 612.

As depicted within FIG. 9, the interactive snippet field 510 has been updated with the following additional fields, which are provided as an example only. The interactive snippet field 510 has been updated with a booking selection field 902. The booking selection field 902 is further associated with a route summary field 904. The route summary field 904 includes information summarizing the trip, based on the information (i) provided by the user, such as the route from and to points; and (ii) information obtained from the resource associated with the search result 502, such as the approximate cost of the trip.

The interactive snippet field 510 has been further updated with a user personal details field 906. Within the specific example provided, the user personal details field 906 enables the user to enter her personal details to enable her to hook the service with the resource associated with the search result 502. Within the specific example, the user personal details field 906 includes the last name of the user, the contact telephone number and the time associated with the requested service.

Upon the user pressing an order button 908 (or, alternatively, automatically upon the user completing the user personal detail field 906), the interactive snippet field 510 transmits the data element representative of the information entered by the user into the user personal detail field 906 to the resource associated with the search result 502. It should be noted that even though the order button 908 is described as an actual button, it can also take a form of a link or any other form factor.

The transmission of the data element can be executed via the above-described API. Even though the order button 908 is depicted as being in addition to the order button 620, in alternative embodiments, once the order button 908 is shown, the order button 620 can be removed, greyed our or, otherwise, rendered inoperable.

Upon receipt of the data element from the interactive snippet field 510, the resource associated with the search result 502 is configured to book the service based on the information received from the interactive snippet field 510 (including all or some of the information that has been capture using the user personal details field 906, the “from” field 720 and the “to” field 722. How the resource associated with the search result 502 processes the request is not particularly limited. For example, the resource associated with the search result 502 can make an entry into an internal booking system based on the details received from the interactive snippet field 510. Alternatively and depending on the type and time of service being requested, the resource associated with the search result 502 can dispatch the service right away.

In some embodiments of the present technology, the resource associated with the search result 502 generates another data element with a confirmation of the service being booked and transmits the data element to the interactive snippet field 510. Responsive to the receipt of the data element from the resource associated with the search result 502, the interactive snippet field 510 is further updated with an order confirmation field 910. Within this example, the order confirmation field 910 contains information confirming the service order that the user executed using the interactive snippet field 510.

In particular, the order confirmation field 910 contains information representative of the route (based on the information obtained from the user using the “from” field 720 and the “to” field 722), information representative of the time for the taxi ride to start (based on the information obtained from the user using the user personal details field 906), approximate price (based on the information provided by resource associated with the search result 502), and personal details of the user ordering the service (based on the information obtained from the user using the user personal details field 906).

The interactive snippet field 510 further includes a cancel button 912, the cancel button 912 for enabling the user to cancel the order that has ben placed using the interactive snippet field 510 without leaving the SERP that hosts the search result 502.

Given the examples provided above with reference to FIGS. 5 to 9, what has been depicted are various illustrations as to how the interactive snippet field 510 can be updated based on (i) a first data component received based on interaction of the user with the interactive snippet field 510 and (ii) a second data component received from the resource associated with the search result 502. It should be noted that several ones of the first data component and several ones of the second data component can be exchanged between the interactive snippet field 510 and the resource associated with the search result 502.

Furthermore, what has been illustrated is a real-time update of the interactive field 510 based, at least in part, on one or both of (i) the first data component received based on interaction of the user with the interactive snippet field 510 and (ii) the second data component received from the resource associated with the search result 502. This real time update can be done, at least in part, due to the two-way communication established between the interactive snipped field 510 and the resource associated with the search result 502.

It is noted and as has been shown above, this two-way communication can be established based on an affirmative action from the user (such as actuation of the order button 620 and the like). Alternatively, the two-way communication can be established without an affirmative action from the user. The latter is particularly useful (but is not limited to) in those embodiments where it may be beneficial to update data within the interactive snippet field 510 in real time.

Just as example, a reference will be made to FIG. 8 and the current availability field 512. For this illustration, let us assume that the user has loaded on the screen of the electronic device the page represented with the screen shot 800. Recalling that the trip details field 612 contains information representative of the approximate trip cost and the approximate trip duration, let's assume that there was an accident on the route between the starting point and the destination point, as specified within the “from” field 720 and the “to” field 722.

In some embodiments of the present technology, the resource associated with the search result 502 may become aware of such an accident (in a conventional manner) and may update the information representative of either the trip duration and/or trip cost. Recalling that there exists a two way communication between the interactive snippet field 510 and the resource associated with the search result 502, the resource associated with the search result 502 can compile and release a data element containing the updated information. The interactive snippet field 510 can receive the data element and to further update the trip details field 612 based on the new information received from the resource associated with the search result 502.

It is noted that the update described immediately above can be performed without any additional user interaction with the interactive snippet field 510. In some embodiments, the interactive snippet field 510 can check for any potentially updated information from the resource associated with the search result 502 on a periodic basis, while the interactive snippet field 510 is displayed on the SERP (i.e. while the SERP page is up, prior to the user closing the window, or changing the pages within SERP).

Alternatively, the resource associated with the search result 502 can push updates to the interactive snippet field 510 on a periodic basis, while the interactive snippet field 510 is displayed on the SERP (i.e. while the SERP page is up, prior to the user closing the window or tab, or changing the pages within SERP). Yet in further embodiments, the resource associated with the search result 502 can push updates to the interactive snippet field 510 as events warranting the change occur (in this example, as the accident is detected).

It should be noted that the updated information for the above updates to the interactive snippet field 510 can be exchanged via the aforementioned APIs.

It should be further understood that the interactive snippet field 410, 510 can be generated based on the results from general search or one or more vertical searches, all of which were described above.

Therefore, it has been described above how the interactive snippet field 410, 510 is changed and/or updated based on (i) the first data component received based on interaction of the user with the interactive snippet field 410, 510 and (ii) the second data component received from the resource associated with the search result 402, 502. The interactive snippet field 410, 510 can be further updated based on several parameters to make it more user friendly, more user relevant or the like.

For example the interactive snippet field 410, 510 can be further updated based on user interaction with the interactive snippet field 410, 510 in the current session. Alternatively or additionally, the interactive snippet field 410, 510 can be further updated based on user interaction with the interactive snippet field 410, 510 in the previous sessions (for example, which history of interactions can be saved in association with a given user profile in a user database associated with the server 316 or the interactive snippet server 340 or even locally on the electronic device 302).

For example, if it is known that the user usually looks for weather in a particular region or orders delivery to a particular address, this information could be pre-populated into one or more of the fields of the interactive snippet field 410, 510. As another example, the user personal details (such as name, telephone number, address and the like) could also be pre-populated into one or more fields of the interactive snippet field 410, 510.

Now, it should be expressly understood that the above description of the interactive snippet field 410 and the interactive snippet field 510 is meant as examples only. The information and the lay out of the interactive snippet field 410, 510 can take many forms. As such, the two examples provided above (booking a taxi and searching cars for sale classifieds) are just two examples. The information exchanged through the two way communication between the interactive snippet field 410, 510 can be associated with various subjects, such as but not limited to: booking of services (a flight, a hotel, a haircut, a spa appointment, or the like); purchasing wares (such as a book, a CD, a music file to download, order a pizza and the like); information search (such as search and apply for jobs, perform Internet banking transactions, etc). In alternative embodiments, additionally or alternatively, the interactive snippet field 410, 510 could allow the user to make the payment for one or more services or one or more wares ordered or purchased through the interactive snippet field 410, 510. Those embodiments would require proper encryption techniques implemented for exchange of information (through APIs or otherwise), as is known to those of skill in the art.

Generally speaking, the interactive snippet field 410, 510 allows for interaction with the resource associated with the interactive snippet field 410, 510 without leaving the SERP that hosts the interactive snippet field 410, 510. What it can mean, in the general sense, is that the interactive snippet field 410, 510 allows the user to make interactions with the resource associated with the interactive snippet field 410, 510 without actually visiting the web site associated with the resource associated with the interactive snippet field 410, 510.

What this can mean in turn is that the web master or operator of the resource associated with the interactive snippet field 410, 510 may not need to build full interactive functionality on their web site. They could, instead, provision the interactive snippet field 410, 510 (as has been described above) to allow the user to make interactions directly from the SERP hosting interactive snippet field 410, 510. In some embodiments of the present technology, a premium fee mat be charged by the operator of the interactive snippet server 416 for allowing web masters of the resources to use the interactive snippet functionality.

For example, the above mentioned example of the taxi service the web master or the operator of the web site may choose to provision the interactive snippet field 410, 510 and not to build an ordering functionality into the web site itself. That may allow to offer interactivity to the user through the SERP hosting interactive snippet field 410, 510, while at the same time allowing the web master or the operator of the resource associated with the interactive snippet field 410, 510 to save costs associated with development or hosting or maintenance of the web site.

Naturally, the functionality of the interactive snippet field 410, 510 can be provided in addition to any interactive functionality provided directly on the web site associated with the resource associated with the interactive snippet field 410, 510. In other words, the functionality of the interactive snippet field 410, 510 can duplicate the functionality present on the website of the resource associated with the interactive snippet field 410, 510.

From the resource perspective, the interactive snippet field 410, 510 allows for the resource to push up-to-date and/or real life information to the user directly through the SERP hosting the interactive snippet field 410, 510. As the interactive snippet field 410, 510 allows for the two way communication and the APIs described above allow for real-time exchange of information, the type of content that the resource can push to the interactive snippet field 410, 510 is truly not limited.

From the search engine perspective the interactive snippet field 410, 510 allows the search engine to present relevant and up-to-date information on the SERP, which can even be updated in real-time. This can potentially lessen the burden of constant crawling of Internet resources in the pursuit of generating up-to-date search indices. The interactive snippet field 410, 510 may be able to ensure that the information about the resource associated with the interactive snippet field 410, 510 presented to the user is up-to-date, as it would come directly from the resource and could be updated in real-time.

From the user perspective it can be said that the interactive snippet field 410, 510 allows the user to obtain information (or generally to address one or more of user's goals or problems) directly from the SERP. Put another way, the user can perform the interaction with the resource that she needs to address her problem or goal by searching and interacting with the interactive snippet field 410, 510 without leaving the SERP (i.e. without actually accessing the web page associated with the resource that is associated with the interactive snippet field 410, 510).

Given the architecture described with reference to FIG. 3 and the examples of the interactive snippet field 410, 510 provided with reference to FIGS. 4-9, it is possible to execute a method of presenting a SERP to a user in response to a search query. The method can be conveniently executable at the server 316 (or the interactive snippet server 340). To that extent, the server 316 or the interactive snippet server 340 (as the case may be) comprises non-transient computer usable information storage medium that enables the server 316 or the interactive snippet server 340 (as the case may be) to execute the method in accordance with embodiments of the present technology. For the sake of an example, the method 1000 will be illustrated as executed on the server 316.

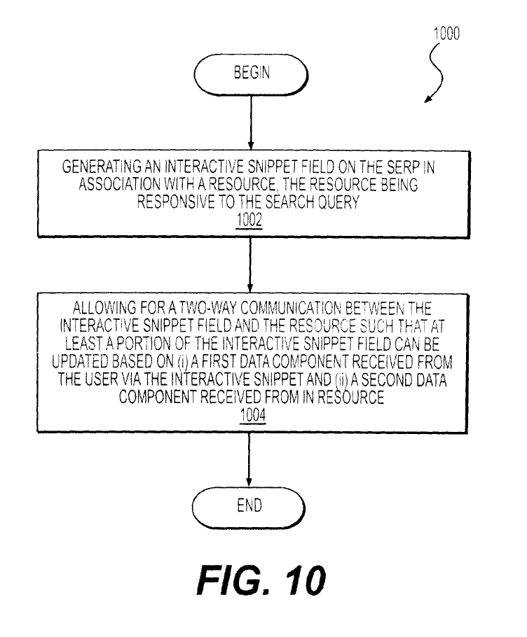

With reference to FIG. 10, there is depicted a non-limiting of a method 1000, the method 1000 for presenting a SERP to a user in response to a user query.

Step 1002—Generating an Interactive Snippet Field on the SERP in Association with a Resource, the Resource being Responsive to the Search Query

The method 100 begins at step 1002, where the server 316 generates an interactive snippet field 410, 510 on a SERP in association with a resource, the resource being responsive to a search query having been submitted by the user. How the search query is received and processed is generally implemented in accordance with known techniques, some of which have been described herein above.

In some embodiments, the server 316 generates the interactive snippet field 410, 510 based on the information provided by the resource associated with the interactive snippet field 410, 510. As has been described above, the operator associated with the resource associated with the interactive snippet field 410, 510 may provision information required to generate the lay out and/or the content of the interactive snippet field 410, 510.

Depending on the embodiments and as has been described above, the information required to generate the interactive snippet field 410, 510 can be received from the resource associated with the interactive snippet field 410, 510 as part of the web page itself or as a separate file. In some embodiments, the receiving of this information is performed in advance of executing the method 1000 (for example, it can be received as part of regular Internet crawling and can be stored in memory in association with the server 316 in association with the resource). Within the latter embodiment, the server 316 can retrieve the information from the memory and use the information to generate the interactive snippet field 410, 510.

The method 1000 then proceeds to step 1004.

Step 1004—Allowing for a Two-Way Communication Between the Interactive Snippet Field and the Resource Such that at Least a Portion of the Interactive Snippet Field can be Updated Based on (i) a First Data Component Received from the User Via the Interactive Snippet and (ii) a Second Data Component Received from the Resource.

Next, at step 1004, the server 316 allows for a two-way communication between the interactive snippet field 410, 510 and the resource associated with the interactive snippet field 410, 510 such that at least a portion of the interactive snippet field 410, 510 can be updated based on (i) a first data component received from the user via the interactive snippet field 410, 510 and (ii) a second data component received from the resource.

As has been explained at length above, the first data component and the second data component (or plural implementations thereof) can be exchanged between the interactive snippet field 410 and the resource associated with the interactive snippet field 410 via the above-described APIs.

The method 1000 can then loop back to execution of step 1004. In other words, the method 1000 can continue updating the interactive snippet field 410, 510. In some embodiments, the interactive snippet field 410, 510 is updated in response to the user changing information in one or more fields of the interactive snippet field 410, 510. Alternatively, the interactive snippet field 410, 510 can be updated automatically, for example, in response to information changes at the server associated with the interactive snippet field 410, 510.

It is noted that in some embodiments, the interactive snippet field 410, 510 is presented to the user without generating a pop-window or otherwise augmenting presentation of the rest of the SERP.

Furthermore, it is notes that the interactive snippet field 410, 510 can be associated with any resource, not necessarily with a specific vertical search result or a paid-for or advertising content. In other words, the interactive snippet field 410, 510 is presented as part o the general search results within the SERP and can be associated with any resource, which has provisioned the necessary provisioning information and/or APIs.

Even thought the various exchanges of information between the interactive snippet field 410, 510 and the associated resource has been described via APIs directly between the interactive snippet field 410, 510 and the associated resource, alternatively the exchange of information can be executed via the server 316 or the interactive snippet server 340 (which can also be executed by means of respective APIs).

It is also noted that once the transaction is performed using the interactive snippet field 410, 510, the availability data within the resource associated with the interactive snippet field 410, 510 can be updated. For example, if the user has booked a taxi service, the availability of taxis will be affected and, therefore, information depicted in the current availability field 512 will be changed.

Execution of the method 1000 can be terminated upon user completing a transaction using the interactive snippet field 410, 510: upon user closing the browser window or tab hosting the SERP that hosts the interactive snippet field 410, 510; upon user selecting a different page in the SERP or otherwise indicating the user desire to stop interacting with the interactive snippet field 410, 510.

In some embodiments of the present technology, there is provided a method of provisioning an interactive snippet in association with a resource. The method can be executed at an electronic device (such as device similar to the electronic device 302) associated with an operator of the resource. The method comprises: (i) providing provisioning information, the provisioning information for enabling generation of an interactive snippet field on a search result page (SERP) in association with the resource, the resource being responsive to a search query; and (ii) the interactive snippet field for allowing for a two-way communication between the interactive snippet field and the resource such that at least a portion of the interactive snippet field can be updated based on (i) a first data component received from the user via the interactive snippet field and (ii) a second data component received from the resource.

In other embodiments of the present technology, there is provided a method of operating a resource for presenting information to a user in response to a search query. The method comprises: providing provisioning information, the provisioning information for enabling generation of an interactive snippet field on a search result page (SERP) in association with the resource, the resource being responsive to a search query: defining at least one API for allowing for a two-way communication between the interactive snippet field and the resource such that at least a portion of the interactive snippet field can be updated based on (i) a first data component received from the user via the interactive snippet field and (ii) a second data component received from the resource.

In some embodiments of the present technology, the Web master associated with the resource can execute the method of provisioning in lieu of building a web site or a landing page associated with the resource.

It should be noted that even though the above interactive snippet has been described as being associated with a single resource, in some embodiments of the present technology two or more interactive snippets, each potentially associated with a separate resource, can be grouped together and displayed as part of a master interactive snippet.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of presenting a search result page (SERP) to a user in response to a search query, the method executable at a server, the method comprising:
generating a first interactive snippet field on the SERP in association with a first resource, the first resource being responsive to the search query;
generating a second interactive snippet field on the SERP in association with a second resource, the second resource being responsive to the search query;
allowing for a two-way communication between the respective ones of (i) the first interactive snippet field and the first resource and (ii) the second interactive snippet field and the second resource,
such that at least a portion of the first interactive snippet field can be updated based on (i) a first data component received from the user via the first interactive snippet field and (ii) a second data component received from the first resource;
such that at least a portion of the second interactive snippet field can be updated based on (i) a first data component received from the user via the second interactive snippet field and (ii) a second data component received from the second resource.

2. The method of claim 1, wherein said generating the interactive snippet field comprises generating said interactive snippet field based at least in part on a parameter pre-defined by the resource.

3. (canceled)

4. The method of claim 3, further comprising receiving said parameter from the resource, wherein said receiving said parameter is executed prior to a point of time when the user has submitted the search query.

5. The method of claim 3, further comprising receiving said parameter from the resource, wherein said receiving said parameter is executed at a point of time when the user has submitted the search query.

6. (canceled)

7. The method of claim 3, further comprising receiving said parameter from the resource wherein said receiving said parameter is executed after a point of time when the user has submitted the search query.

8-13. (canceled)

14. The method of claim 1, wherein said two-way communication is established by means of an application programming interface (API).

15. The method of claim 1, wherein said allowing for a two-way communication between the interactive snippet field and the resource comprises:
transmitting said first data component to the resource; and
receiving said second data component received the resource.

16. (canceled)

17. The method of claim 2, wherein said parameter is instrumental in causing the server to generate a user interface within at least one of the first interactive snippet field and the second interactive snippet field, the user interface for enabling the user to input said first data component.

18. The method of claim 17, wherein said first data component is representative of a further refinement of the search query pertaining to the resource.

19. The method of claim 17, wherein said first data component is representative of a transaction the user is desirous of performing with the resource.

20. The method of claim 19, wherein said interactive snippet field allows the user to complete the transaction with the resource without leaving the SERP.

21. The method of claim 19, wherein said interactive snippet field allows the user to complete the transaction with the resource without accessing a web site associated with the resource.

22. The method of claim 1, wherein said second data component is based at least partially on the first data component.

23-26. (canceled)

27. The method of claim 1, wherein at least one of the first interactive snippet field and the second interactive snippet field is based at least in part on a parameter pre-defined by the resource and wherein said parameter is instrumental in causing the server to generate a user interface within the at least one of the first interactive snippet field and the second interactive snippet field, the user interface for displaying an indication of the second data component.

28. The method of claim 1, wherein the first data component of at least one of the first interactive snippet field and the second interactive snippet field is representative of a transaction to be made with the resource, and wherein the at least one of the first interactive snippet field and the second interactive snippet field allows for the transaction to be executed without leaving the SERP.

29. The method of claim 1, wherein the first data component is representative of a transaction to be made with the resource, and wherein at least one of the first interactive snippet field and the second interactive snippet field allows for the transaction to be executed without accessing a web site associated with the resource.

30. (canceled)

31. The method of claim 2, further comprising receiving provisioning information associated with the parameter pre-defined by the resource, wherein said receiving provisioning information is executed prior to said generating.

32. The method of claim 2, further comprising receiving provisioning information associated with the parameter pre-defined by the resource, wherein said provisioning information is said second data component.

33. The method of claim 2, further comprising receiving provisioning information associated with the parameter pre-defined by the resource, wherein said receiving provisioning information comprises presenting a provisioning web site to an operator associated with the resource.

34-40. (canceled)

41. A server configured for presenting a search result page (SERP) to a user in response to a search query, the server having a transient computer usable information storage medium that stores computer executable instructions, which instructions when executed are configured to render the server operable to execute the steps of:
generating a first interactive snippet field on the SERP in association with a first resource, the first resource being responsive to the search query;
generating a second interactive snippet field on the SERP in association with a second resource, the second resource being responsive to the search query;
allowing for a two-way communication between the respective ones of (i) the first interactive snippet field and the first resource and (ii) the second interactive snippet field and the second resource,
such that at least a portion of the first interactive snippet field can be updated based on (i) a first data component received from the user via the first interactive snippet field and (ii) a second data component received from the first resource;
such that at least a portion of the second interactive snippet field can be updated based on (i) a first data component received from the user via the second interactive snippet field and (ii) a second data component received from the second resource.

42-123. (canceled)
